(19) United States
(12) Patent Application Publication
(10) Pub. No.: US 2024/0056897 A1
(43) Pub. Date: Feb. 15, 2024

(54) METHOD AND APPARATUS FOR MANAGING EDGE COMPUTING SERVICE SESSION IN WIRELESS COMMUNICATION SYSTEM

(71) Applicant: Samsung Electronics Co., Ltd., Gyeonggi-do (KR)

(72) Inventors: Hyesung KIM, Gyeonggi-do (KR); Jicheol LEE, Gyeonggi-do (KR)

(21) Appl. No.: 18/446,848

(22) Filed: Aug. 9, 2023

(30) Foreign Application Priority Data
Aug. 9, 2022 (KR) 10-2022-0099139

(51) Int. Cl. H04W 28/22; H04L 67/141

(52) U.S. Cl. CPC H04W 28/22; H04L 67/141

(57) ABSTRACT

The disclosure relates to a 5G or 6G communication system for supporting a higher data transmission rate. A method performed by a first session management function (SMF) entity includes receiving, from a second SMF entity, a request message for a protocol data unit (PDU) session associated with a home routed (HR) local session, receiving, from a unified data management (UDM) entity, information on an aggregated maximum bit rate (AMBR) for the HR local session, receiving, from a policy control function (PCF) entity, an authorized AMBR of the HR local session generated based on the information on the AMBR, and transmitting, to the second SMF, a response message including the authorized AMBR.

### CROSS-REFERENCE TO RELATED APPLICATION(S)

This application is based on and claims priority under 35 U.S.C. § 119 to Korean Patent Application No. 10-2022-0099139, filed on Aug. 9, 2022, in the Korean Intellectual Property Office, the disclosure of which is incorporated herein by reference in its entirety.

### BACKGROUND

### 1. Field

The disclosure relates to a wireless communication system and, more particularly, to a method and apparatus for managing an edge computing service session in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Disclosed embodiments provide an apparatus and a method capable of effectively providing a service in a wireless communication system.

According to an embodiment, a method performed by a session management function (SMF) includes an operation of receiving, from an access and mobility management function (AMF), a protocol data unit (PDU) session establishment request message including a home routed (HR) local session establishment allow indicator, an operation of requesting, based on the received PDU session establishment request message, HR roaming-related subscriber information from a unified data management (UDM), an operation of selecting a user plane function (UPF) that supports data network local access in a visited network, and an operation of configuring application of an aggregated maximum bit rate (AMBR) related to the HR local session to the UPF.

According to an embodiment, a method performed by a first session management function (SMF) entity includes receiving, from a second SMF entity, a request message for a protocol data unit (PDU) session associated with a home routed (HR) local session; receiving, from a unified data management (UDM) entity, information on an aggregated maximum bit rate (AMBR) for the HR local session; receiving, from a policy control function (PCF) entity, an authorized AMBR of the HR local session generated based on the information on the AMBR; and transmitting, to the second SMF, a response message including the authorized AMBR.

According to an embodiment, a method performed by a unified data management (UDM) entity includes receiving, from a first session management function (SMF) entity, information on a protocol data unit (PDU) session; and transmitting, to the first SMF entity, information on an aggregated maximum bit rate (AMBR) associated with the PDU session, wherein an authorized aggregated maximum bit rate (AMBR) of a home routed (BR) local session is generated based on the information on the AMBR, and wherein the authorized AMBR is transmitted to a second SMF entity in response to a request message for the PDU session.

According to an embodiment, a first session management function (SMF) entity in a wireless communication system includes a transceiver; and at least one processor coupled with the transceiver and configured to receive, from a second SMF entity, a request message for a protocol data unit (PDU) session associated with a home routed (HR) local session, receive, from a unified data management (UDM) entity, information on an aggregated maximum bit rate (AMBR) for the HR local session, receive, from a policy control function (PCF) entity, an authorized AMBR of the HR local session generated based on the information on the AMBR, and transmit, to the second SMF, a response message including the authorized AMBR.

According to an embodiment, a unified data management (UDM) entity in a wireless communication system includes a transceiver; and at least one processor coupled with the transceiver and configured to receive, from a first session management function (SMF) entity, information on a protocol data unit (PDU) session, and transmit, to the first SMF entity, information on an aggregated maximum bit rate (AMBR) associated with the PDU session, wherein an authorized AMBR of a home routed (HR) local session generated based on the information on the AMBR, and wherein the authorized AMBR is transmitted to a second SMF entity in response to a request message for the PDU session.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a scenario of embodying edge computing configured without distinguishing hierarchy according to an embodiment;

FIG. 2 illustrates a service scenario in which an edge computing session of a predetermined user equipment (UE) is established in a home-routed roaming scenario according to an embodiment;

FIG. 3 illustrates a scheme of applying a V-SMF-based HR local session-AMBR according to an embodiment;

FIG. 4 illustrates a scheme of applying an AMF-based HR local session-AMBR according to an embodiment;

FIG. 5 illustrating a scheme of applying an H-SMF-based HR local session-AMBR according to an embodiment;

FIG. 6 illustrates a scheme of updating an HR local session-AMBR disclosed by an SMF according to an embodiment;

FIG. 7 illustrates a scheme of updating an HR local session-AMBR disclosed by a PCF according to an embodiment;

FIG. 8 illustrates a block diagram of the structure of a UE according to an embodiment;

FIG. 9 illustrates a block diagram of the structure of a base station according to an embodiment; and

FIG. 10 illustrates a block diagram of the structure of a network entity according to an embodiment.

### DETAILED DESCRIPTION

Hereinafter, the operation principle of the disclosure will be described in detail with reference to the accompanying drawings. In describing the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings and this specification, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, the term “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description, terms referring to network entities and entities of an edge computing system, terms referring to messages, terms referring to identification information, and the like are illustratively used for the sake of descriptive convenience. Therefore, the disclosure is not limited by the terms as used below, and other terms referring to subjects having equivalent technical meanings may be used.

The description of embodiments of the disclosure is mainly directed to new radio (NR) as a radio access network and packet core 5G system or 5G core network or next generation core (NG Core) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, terms and names defined in the 3GPP standards (standards for 5G, NR, long term evolution (LTE), or similar systems) may be used for the sake of descriptive convenience. However, the disclosure is not limited by these terms and names, and may be applied in the same way to systems that conform other standards.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station.

In particular, the disclosure may be applied to 3GPP NR (5th generation mobile communication standard). Furthermore, the disclosure may be applied to intelligent services (e.g., smart homes, smart buildings, smart cities, smart cars or connected cars, healthcare, digital education, retail business, security and safety-related services, etc.) on the basis of 5G communication technology and IoT-related technology. In the disclosure, the term “eNB” may be interchangeably used with the term “gNB”. That is, a base station described as “eNB” may indicate “gNB”. In addition, the term “terminal” may refer to not only mobile phones, NB-IoT devices, and sensors, but also other wireless communication devices.

A wireless communication system is advancing to a broadband wireless communication system for providing high-speed and high-quality packet data services using communication standards, such as high-speed packet access (HSPA) of 3GPP, LTE, evolved universal terrestrial radio access (E-UTRA), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink. The uplink indicates a radio link through which a UE (or an MS) transmits data or control signals to a BS (or eNode B), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include eMBB communication, mMTC, URLLC, and the like.

According to an embodiment, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced MIMO transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as IoT in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since Tot provides communication functions while being provided to various sensors and various devices, it must support a large number of UEs (e.g., 1,000,000 UEs/km\hat{ }2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10\hat{ }-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In order to satisfy different requirements of the respective services, different transmission/reception techniques and transmission/reception parameters may be used between the services. However, the above mMTC, URLLC, and eMBB are merely examples of different types of services, and service types to which the disclosure is applied are not limited to the above examples.

The disclosure provides a method of configuring and applying quality of service (QoS) (e.g., an aggregate maximum bit rate (AMBR)) with respect to an edge computing session. Specifically, the disclosure provides a method of specifying an edge computing session in a single protocol data unit (PDU) session and applying a QoS constraint for each local part of a data network (DN). According to an embodiment, there is provided a method in which a session management function (SMF) obtains an AMBR associated with an edge computing session from a policy control function (PCF) and configures the same with respect to a user plane function (UPF), and a method in which a UPF applies or implements (enforcement) an AMBR with respect to an edge computing session in a UPF.

In the case of an edge computing service session, traffic in a single PDU session is transmitted to a local part of a data network via diverging. In case that it is desired to apply QoS (e.g., AMBR) only to edge computing service traffic, an existing session-AMBR may not be utilized. The existing session-AMBR is applicable as the maximum bit rate for the entirety of non-GBR (guaranteed bit rate) QoS flows of a single PDU session, but does not support applying an AMBR only to traffic that is transmitted to a local part of a data network when a single PDU session diverges. Such the situation may happen when an edge computing service is provided to a UE that is in roaming. For example, in case that a UE in roaming uses a home-routed PDU session, an AMBR is not applicable to a divergent session in a visited network.

Network operators may produce and apply a QoS policy with respect to only an edge computing service session. Network operators may variously apply an edge computing service policy based on a payment system according to such a QoS policy. In addition, by managing QoS of an edge computing service session in a visited network when a UE receives a roaming service, a policy based on service level agreement may be secured.

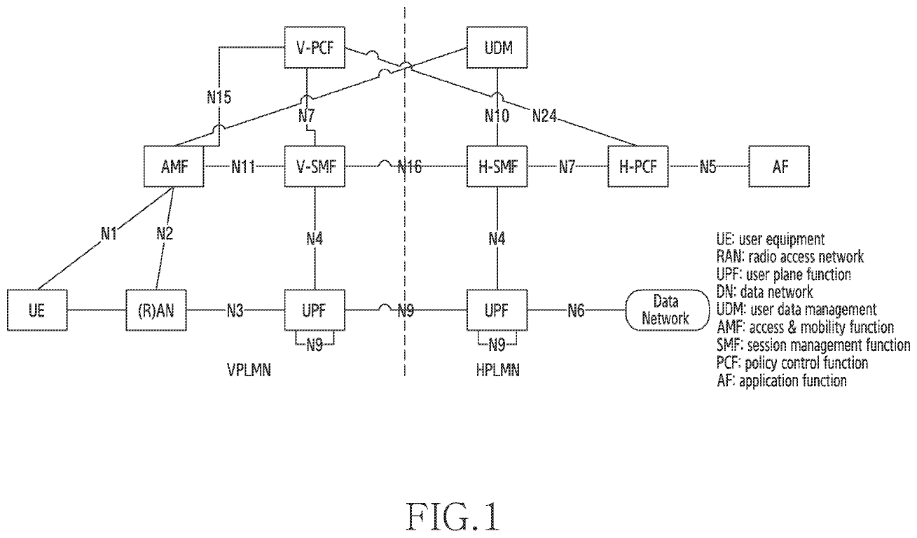

FIG. 1 illustrates a scenario of embodying edge computing configured without distinguishing hierarchy according to an embodiment.

A 5G system structure that supports home routed (HR) roaming may include various network functions (NF) (hereinafter, interchangeably used with a network entity), and FIG. 1 illustrates a 5G system structure including an access and mobility management function (AMF), a session management function (SMF), a policy control function (PCF), an application function (AF), a unified data management (UDM), a data network (DN), a user plane function (UPF), a (radio) access network ((R)AN), and a UE, which correspond to part of the various functions. The 5G system structure is not limited to the example, and may include more or fewer number of NFs than the NFs illustrated in FIG. 1.

Each NF may support a function as follows, although is not limited to the following example.

An AMF may provide a function for access and mobility management in a unit of a UE. A single UE may be connected to a single AMF, and the disclosure is not limited thereto. A visited-AMF (V-AMF) is an AMF in a visited network from the perspective of a UE subscriber. A home-AMF (H-AMF) is an AMF of a home network of a UE subscriber. Specifically, an AMF may perform at least one function among signaling between core network nodes for mobility between 3GPP access networks, an interface (N2 interface) between radio access networks (e.g., 5G RAN), NAS (non-access stratum) signaling with a UE, identification of an SMF, and transferring a session management (SM) message between a UE and a SMF. Some or all of the functions of an AMF may be supported in a single instance of a single AMF.

A DN may include, for example, a network providing a service, an operator service, and an Internet access or third party (3rd party) service. A DN may transmit a downlink protocol data unit (PDU) to a UPF or may receive, from a UPF, a PDU transmitted from a UE.

A PCF may receive information associated with a packet flow from an application server, and may provide a function of determining a policy associated with mobility management, session management, and the like. Specifically, the PCF may support functions such as supporting a unified policy framework to control network operations, providing policy rules so that a control plane function(s) (e.g., an AMF, an SMF, and the like) implements the policy rules, implementing a front end for accessing related subscription information for determining a policy in a user data repository (UDR), and the like.

An SMF may provide a session management function, and in the case in which a UE has a plurality of sessions, the sessions may be managed by different SMFs, respectively. A visited-SMF (V-SMF) is an AMF of a visited network from the perspective of a UE subscriber. A home-SMF (H-SMF) is an SMF of a home network of a UE subscriber. Specifically, an SMF may perform at least one function among session management (e.g., session establishment, correction, and release including maintaining of a tunnel between a UPF and an access network node), selecting and controlling a user plane (UP) function, configuring, by a UPF, traffic steering for routing traffic to an appropriate destination, termination of an SM part of a NAS message, a downlink data notification (DDN), and an initiator of AN-specific SM information (e.g., transferring to an access network via an N2 interface by passing through an AMF). Some or all of the functions of an SMF may be supported in a single instance of a single SMF.

A UDM may store user subscription data, policy data, and the like.

A UPF transfers a downlink PDU received from a DN to a UE via a (radio) access network ((R)AN), and transfers an uplink PDU received from a UE to a DN via a (R)AN.

An AF interoperates with a 3GPP core network in order to provide a service (e.g., supporting functions such as application effect on traffic routing, accessing network capability exposure, interoperating with a policy framework for policy control, or the like).

In the 3GPP system, conceptual links that connect NFs in the 5G system are referred to as reference points. A reference point may also be referred to as an interface. Reference points (hereinafter, interchangeably used with interfaces) included in a 5G system architecture expressed in various embodiments of the disclosure are as follows:
N1: a reference point between a UE and an AMF
N2: a reference point between an (R)AN and an AMF
N3: a reference point between an (R)An and a UPF
N4: a reference point between an SMF and a UPF
N5: a reference point between a PCF and an AF
N6: a reference point between a UPF and a DN
N7: a reference point between an SMF and a PCF
N8: a reference point between a UDM and an AMF
N9: a reference point between two core UPFs
N10: a reference point between a UDM and an SMF
N11: a reference point between an AMF and an SMF
N12: a reference point between an AMF and an authentication server function (AUSF) 151
N13: a reference point between a UDM and an authentication server function
N14: a reference point between two AMFs
N15: a reference point between a PCF and an AMF in the case of a non-roaming scenario, and a reference point between a PCF and an AMF in a visited network in the case of a roaming scenario
N16: a reference point between a V-SMF and an H-SMF
N24: a reference point between a V-PCF and an H-PCF

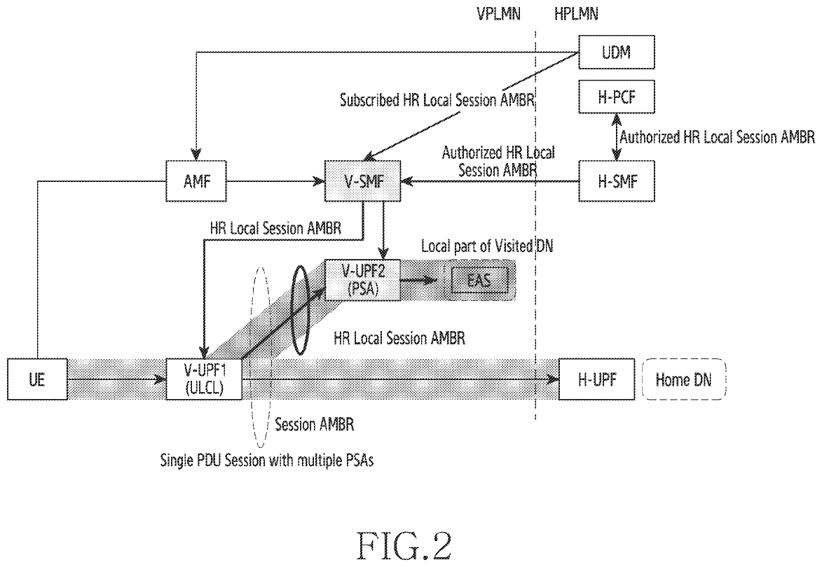

FIG. 2 illustrates a service scenario in which an edge computing session of a predetermined UE is established in a home-routed roaming scenario according to an embodiment.

Referring to FIG. 2, a home-routed (HR) PDU session established by a UE may transfer traffic via two paths. There may be a general traffic session in which transmission is performed from V-UPF1 to a home data network via an H-UPF, and an edge computing service session that diverges from V-UPF1 and in which transmission is performed, via V-UPF2, to a local part of a data network that supports an edge computing service provided in a visited network (visited public land mobile network (VPLMN)). As described above, the edge computing service session that diverges from an HR roaming PDU session and is connected to a local part of a data network may be expressed as an HR local session or an HR edge computing session.

A network operator may apply a separate AMBR to be applied to an HR local session according to an operator policy or in response to a request from an edge computing service supplier (or an application service supplier). The AMBR with respect to the HR local session may be determined based on a subscribed HR local session-AMBR stored in a UDM or based on an authorized HR local session-AMBR produced from a PCF. (HR local session AMBR: AMBR that can be expected to be provided across all non-GBR QoS flows toward/from the local part of a data network for an HR PDU session) For example, a V-SMF may receive a subscribed HR local session-AMBR from a UDM in a home operator network of a roaming UE (via an H-SMF) or may receive an authorized HR local session-AMBR produced by a PCF, and at least one of V-UPF1 or V-UPF2 may apply an AMBR to an HR local session.

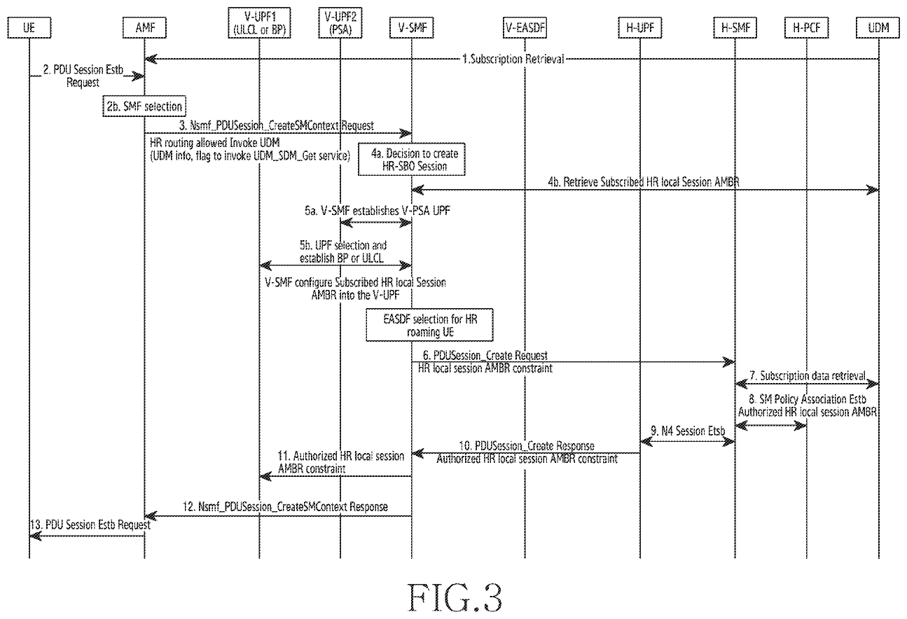

FIG. 3 illustrates a scheme of applying a V-SMF-based HR local session-AMBR according to an embodiment.

Referring to FIG. 3, in Operation 1, an AMF may receive, from a UDM, information associated with whether to allow an HR roaming session to diverge (establishment of an HR local session is allowed) (i.e., perform subscription retrieval). Whether to allow an HR roaming session to diverge is configured for each data network name (DNN), single network slice selection assistance information (S-NSSAI), or public land mobile network (PLMN) ID, and may be stored in the UDM. An AMF provides, to the UDM, a PLMN ID that a UE currently accesses and DNN and S-NSSAI information corresponding to a PDU session desired to be established, together, and, in response thereto, may obtain HR roaming session diverging allow information.

In Operation 2, in case that the AMF receives a PDU session establishment request including a PDU session identifier and receives an HR local session establishment allow information in Operation 1 from the UDM, the AMF may select an SMF capable of establishing an HR local session for the corresponding UE in Operation 2b.

In Operation 3, the AMF may transmit the PDU session establishment request message (Nsmf_PDUSession_CreateSMContext Request) to the SMF selected in Operation 2. The PDU session establishment request message may include at least one among a PDU session identifier, an HR local session establishment allow indicator, a flag to invoke a UDM subscription data management service (an indicator that indicates obtaining of session management subscriber information from a UDM), and UDM address information.

In Operation 4, based on the at least one indicator and the flag to invoke UDM subscription data management service received from the AMF, the V-SMF may request, from the UDM, HR roaming-related subscriber information. For example, in case that the V-SMF receives the HR location session establishment allow indicator and the UDM subscription data management service, the V-SMF may determine performing of home-routed session breakout (HR-SBO) for establishing an HR local session (in Operation 4a) and may request, from the UDM, HR roaming-related subscriber information (in Operation 4b). In this instance, the V-SMF may transmit, to the UDM, a data network information value (data network name (DNN)) of a data network which a PDU session that a current UE is to establish heads to and a slice information value (S-NSSAI) of a slice in which the PDU session is to be established. In the UDM, a subscribed HR local session-AMBR may be stored for each DNN or S-NSSAI. Alternatively, a subscribed HR local session-AMBR may be stored in the UDM for each combination of PLMN ID/DNN/S-NSSAI (a different session-AMBR may be applied in the case of access to the same DNN depending on a visited network of a UE). Alternatively, the subscribed HR local session-AMBR may be produced for each combination of PLMN ID/DNN/data network access identifier (DNAI) and may be stored in the UDM. In case that the UDM receives an HR roaming-related subscriber information request from the V-SMF, the UDM may provide the subscribed HR local session-AMBR information as a response. In this instance, the UDM may provide subscribed HR local session-AMBR information corresponding to the DNN or S-NSSAI received from the V-SMF.

In Operation 5, in case that the V-SMF receives the HR local session establishment allow indicator from the AMF in Operation 3, the V-SMF may select a V-UPF (V-UPF2 of FIG. 2) that acts as a PDU session anchor (PSA) that supports local access to a local part of a data network in a visited network (in Operation 5a) and may select a UPF that acts as a uplink classifier (UL CL) or a branching point (BP) (in Operation 5b), and may configure a user plane traffic path. In addition, the V-SMF may determine or identify whether the subscribed HR local session-AMBR obtained in Operation 4 is applicable in a VPLMN, and may configure the same for V-UPF1 and V-UPF2. In addition, the V-SMF may select an edge application server discovery function (EASDF) for an HR roaming UE.

In Operation 6, the V-SMF may select an edge application server discovery function (EASDF) for an HR roaming UE.

Information associated with whether the subscribed HR local session-AMBR is applicable in the VPLMN and an HR local session AMBR constraint value applicable in the VPLMN, and at least one of a PDU session identifier, a UE identifier, a data network access identifier (DNAI) (an identifier indicating an access point of a local part of a data network accessible via V-UPF2), a DNN, and an S-NSSAI may be transmitted to an H-SMF. The above-described information may be included in the PDU session establishment request message (PDUSession_Create_Request), and may be transmitted.

In Operation 7, the H-SMF may obtain session management related subscriber information from the UDM (subscription data retrieval).

In Operation 8, the H-SMF may perform transmission and reception of an SM policy association request and response with an H-PCF, and may establish an SM policy association. The H-SMF may provide, to the H-PCF, at least one of a PDU session identifier, an HR local session AMBR constraint, and a subscribed HR local session-AMBR. In addition, the H-SMF may provide, to the H-PCF, at least one of a PDU session identifier, a UE identifier, a VPLMN ID, a DNN, a DNAI, and an S-NSSAI. In consideration of at least one of the UE identifier, VPLMN ID, HR local session AMBR constraint, and subscribed HR local session-AMBR received from the H-SMF, the H-PCF may produce an authorized HR local session AMBR value and may provide the same to the H-SMF in response to the SM policy association request. The subscribed HR local session-AMBR and the authorized HR local session AMBR may be configured not to be greater than a session-AMBR value of an HR PDU session that includes an edge computing service session.

In Operation 9, the H-SMF may select an H-UPF, and may perform an N4 session establishment procedure for connecting V-UPF1 to the H-UPF.

In Operation 10, the H-SMF may transmit, to the V-SMF, at least one of the authorized HR local session AMBR value and the PDU session identifier obtained in Operation 8. In case that the authorized HR local session AMBR is not established in the previous operation, the H-SMF may only transmit, to the V-SMF, whether configuration of an HR local session AMBR constraint value is allowed or whether application of a subscribed HR local session AMBR is identified.

In Operation 11, upon receiving the authorized HR local session AMBR from the H-SMF, the V-SMF may provide the same to the V-UPF, and may apply (or configure) the same. For example, the V-SMF may configure the authorized HR local session AMBR for the V-UPF (V-UPF1) that performs the function of a UL CL or BP. In addition, the V-SMP may configure the corresponding value for V-UPF2.

In Operation 12, the V-SMF may inform the AMF that the HR local session has been successfully established. That may be provided as a response (Nsmf_PDUSession_CreateSMContext Response) to the message (Nsmf_PDUSession_CreateSMContext Request) in previous Operation 3.

In Operation 13, the AMF may inform the UE that the PDU session has been successfully established (PDU Session Establishment Request).

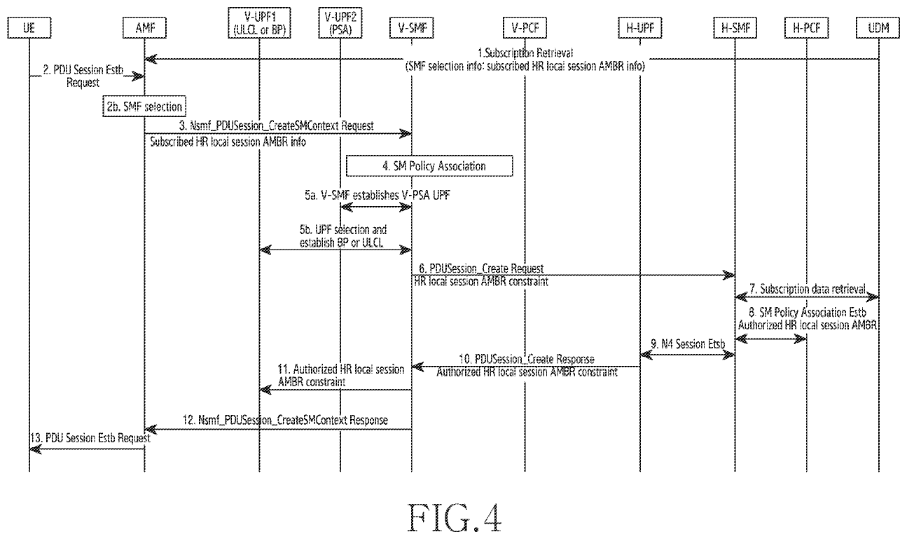

FIG. 4 illustrates a scheme of applying an AMF-based HR local session-AMBR according to an embodiment.

Referring to FIG. 4, in Operation 1, an AMF may obtain, from a UDM, HR local session AMBR information (whether to apply HR local session AMBR information and a subscribed HR local session AMBR value) (i.e., perform subscription retrieval). The HR local session AMBR information provided may have a different value for each DNN or S-NSSAI, and may be provided together with information associated with whether to allow an HR roaming session to diverge.

In Operation 2, in case that the AMF receives a PDU session establishment request from a UE, and application of the HR local session AMBR is identified in Operation 1 as being allowed or available, the AMF may select an SMF capable of establishing an HR local session in Operation 2b.

In Operation 3, the AMF may transmit a PDU session establishment request message (Nsmf_PDUSession_CreateSMContext Request) to the SMF selected in Operation 2. The PDU session establishment request message may include at least one among a PDU session identifier, the HR local session AMBR information (whether to apply the information and the subscribed HR local session AMBR value), and an HR local session establishment allow indicator.

In Operation 4, the V-SMF may transmit an SM policy association request to a V-PCF, together with the HR local session establishment allow indicator, the HR local session AMBR information (whether to apply the information and the subscribed HR local session AMBR value), and the PDU session identifier which are received from the AMF. In addition, the V-SMF may provide, to the V-PCF, the PDU session identifier, a UE identifier, a VPLMN ID, an HPLMN ID, a DNAI (an identifier indicating an access point of a local part of a data network accessible via V-UPF2), a DNN, and an S-NSSAI. In case that application of the HR local session AMBR is needed and the subscribed HR local session AMBR value is received, the V-PCF may determine an HR local session AMBR constraint value which is applicable in a VPLMN, and may provide, to the V-SMF, the same as a response to the SM policy association request.

In Operation 5, in case that the V-SMF receives the HR local session establishment allow indicator from the AMF, the V-SMF may select a V-UPF (V-UPF2 of FIG. 2) acting as a PDU session anchor (PSA) which supports local access to a local part of a data network in a visited network (in Operation 5a) and may select a UPF acting as a UL CL or a branching point (BP) (in Operation 5b), and may configure a user plane traffic path.

In Operation 6, the V-SMF may include the HR local session AMBR constraint value obtained in Operation 4, at least one among the PDU session identifier, the UE identifier, the DNAI (the identifier indicating an access point of a local part of a DN accessible via V-UPF2), the DNN, and the S-NSSAI, and the HR local session establishment allow indicator in the PDU session establishment message (PDU Session Create Request), and may transmit the same to an H-SMF.

In Operation 7, the H-SMF may obtain, from the UDM, subscriber information related to establishment of an HR local session (i.e., subscription data retrieval).

In Operation 8, the H-SMF may establish an SM policy association by performing transmission or reception of an SM policy association request and response with an H-PCF. The H-SMF may include the PDU session identifier, the HR local session AMBR constraint value, and the subscribed session AMBR value, obtained in Operation 6, in the SM policy association request message, and may transmit the same to the H-PCF. In addition, the H-SMF may provide, to the H-PCF, at least one of the PDU session identifier, the UE identifier, and the VPLMN ID. In consideration of the information from the H-SMF, the H-PCF may produce an authorized HR local session AMBR value, and may provide the same to the H-SMF as a response to the SM policy association request.

In Operation 9, the H-SMF may establish a connection between an H-UPF and V-UPF1. That is, the H-SMF may perform an N4 session establishment procedure to establish the connection between the H-UPF and V-UPF1.

In Operation 10, the H-SMF may transmit, to the V-SMF, the authorized HR local session AMBR value and the PDU session identifier obtained from the H-PCF. For example, the H-SMF may transmit the authorized HR local session AMBR value, the PDU session identifier, and the HR local session establishment allow indicator obtained from the H-PCF, to the V-SMF via a PDU session establishment response message (PDUSession_Create Response).

In Operation 11, the V-SMF may configure the authorized HR local session AMBR value for V-UPF1. In addition, the authorized HR local session AMBR value may also be configured for V-UPF2.

In Operation 12, the V-SMF may inform the AMF that a PDU session has been successfully established, as a response (Nsmf_PDUSession_CreateSMContext Response) to previous Operation 3 (Nsmf_PDUSession_CreateSMContext Request).

In Operation 13, the AMF may inform the UE that a PDU session has been successfully established (PDU Session Establishment Request).

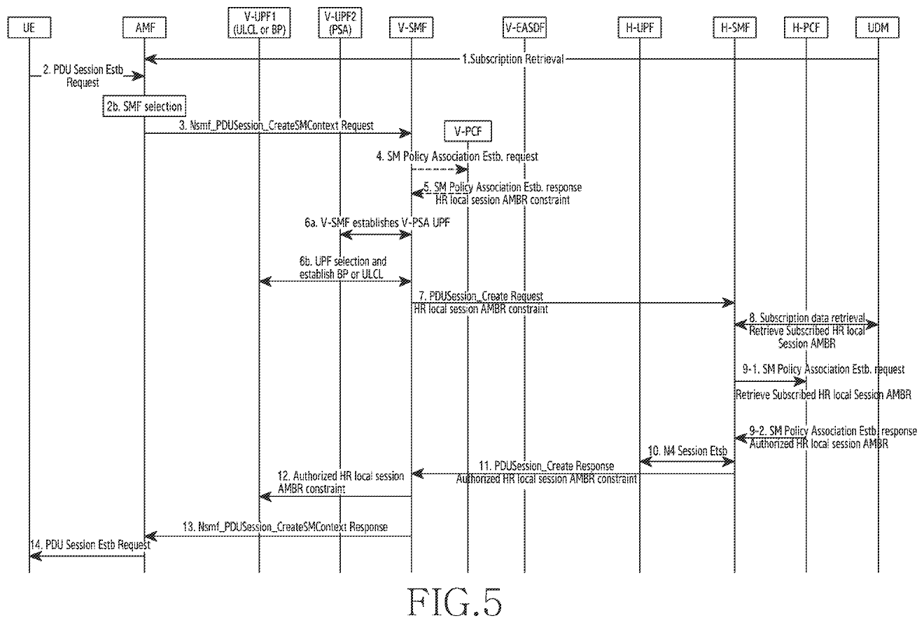

FIG. 5 illustrates a scheme of applying an H-SMF-based HR local session-AMBR according to an embodiment.

Referring to FIG. 5, in Operation 1, an AMF may obtain, from a UDM, whether to allow an HR roaming session to diverge (whether establishment of an HR local session is allowed) (i.e., perform subscription retrieval). Whether to allow an HR roaming session to diverge is configured for each data network name (DNN), a single network slice selection assistance information (S-NSSAI), or a public land mobile network (PLMN) ID, and may be stored in the UDM. The AMF provides, to the UDM, a PLMN ID that a UE currently accesses, together with DNN and S-NSSAI information corresponding to a PDU session to be established and, in response thereto, may obtain information associated with whether to allow an HR roaming session to diverge (e.g., an HR local session establishment allow indicator).

In Operation 2, in case that the AMF receives a PDU session establishment request (PDU Session Establishment Request) including a PDU session identifier from the UE, and application of the HR local session AMBR of the UE is identified in Operation 1 as being allowed or available, the AMF may select an SMF capable of establishing an HR local session in Operation 2b.

In Operation 3, the AMF may transmit a PDU session establishment request message (Nsmf_PDUSession_CreateSMContext Request) to the SMF selected in the previous operation. The PDU session establishment request message may include at least one of a PDU session identifier and an HR local session establishment allow indicator.

In Operation 4, the V-SMF transmits an SM policy association request to a V-PCF, and may transmit, to a V-PCF, at least one of the HR local session establishment allow indicator, the PDU session identifier, a UE identifier, a VPLMN ID, and an HPLMN ID, which are received from the AMF.

In addition, in Operation 5, the V-PCF may determine an HR local session AMBR constraint value applicable in a VPLMN (or applicable to the corresponding UE in a VPLMN), and may provide the same to the V-SMF as a response to the SM policy association request.

In Operation 6, the V-SMF may select a V-UPF (V-UPF2 of FIG. 2) acting as a PDU session anchor (PSA) which supports local access to a local part of a data network in a visited network (in Operation 6a) and may select a UPF acting as a UL CL or a branching point (BP) (in Operation 6b), and may configure a user plane traffic path.

In Operation 7, the V-SMF may include the HR local session AMBR constraint value obtained in Operation 5, at least one of the PDU session identifier, the UE identifier, and the DNAI (the identifier indicating an access point of a local part of a data network accessible via V-UPF2), and the HR local session establishment allow indicator in a PDU session establishment message (PDU Session Create Request), and may transmit the same to an H-SMF.

In Operation 8, the H-SMF may obtain, from the UDM, subscriber information related to establishment of an HR local session (i.e., subscription data retrieval). For example, the H-SMF may transmit, to the UDM, a data network information value (data network name (DNN)) of a data network which a PDU session that a current UE is to establish heads toward and a slice information value (S-NSSAI) of a slice in which the PDU session is to be established.

In the UDM, a subscribed HR local session-AMBR may be stored for each DNN or S-NSSAI. Alternatively, the subscribed HR local session-AMBR may be stored for each combination of a PLMN ID/DNN/S-NSSAI (a different session-AMBR may be applied in the case of access to the same DNN depending on a visited network of a UE). Alternatively, the subscribed HR local session-AMBR may be produced for each combination of PLMN ID/DNN/S-NSSAI/data network access identifier (DNAI) and may be stored in the UDM. In case that the UDM receives an HR roaming related subscriber information request from the V-SMF, the UDM may provide the subscribed HR local session-AMBR information as a response. In this instance, the UDM may provide subscribed HR local session-AMBR information corresponding to the VPLMN ID, DNAI, DNN, or S-NSSAI received from the V-SMF.

In Operation 9, the H-SMF may include the HR local session AMBR constraint value and subscribed session AMBR value, and at least one of the UE identifier, the VPLMN ID, the DNN, the S-NSSAI, and the DNAI value in the SM policy association request message, and transmit the same to an H-PCF (in Operation 9.1). In consideration of a value received from the H-SMF, the H-PCF may produce an authorized HR local session AMBR value, and may provide the same to the H-SMF as a response to the SM policy association request (in Operation 9.2).

In Operation 10, the H-SMF may establish a connection between an H-UPF and V-UPF1. That is, the H-SMF may perform an N4 session establishment procedure to establish the connection between the H-UPF and V-UPF1.

In Operation 11, the H-SMF may transmit, to the V-SMF, the authorized HR local session AMBR value and the HR local session establishment allow indicator obtained from the H-PCF in the previous operation.

In Operation 12, the V-SMF may configure the authorized HR local session AMBR value for V-UPF1. In addition, the V-SMF may also configure the authorized HR local session AMBR value for V-UPF2.

In Operation 13, the V-SMF may inform the AMF that a PDU session has been successfully established as a response (Nsmf_PDUSession_CreateSMContext Response) to Operation 3 (Nsmf_PDUSession_CreateSMContext Request).

In Operation 14, the AMF may inform the UE that a PDU session has been successfully established (PDU Session Establishment Request).

Although the description provided with reference to FIG. 3 to FIG. 5 describes the case in which the H-PCF is disposed and used in an HPLMN, an SMF may perform the operations of the H-PCF described in the disclosure instead in case the H-PCF is not present. The disclosure is not limited to the above-described example, and another network entity instead of the SMF may perform the operation of the H-PCF instead.

In addition, after an HR local session AMBR is applied as described in FIGS. 3 to 5, a method of reporting information associated with a change in a subscribed HR local session AMBR that is incurred by a change in subscriber information is as follows:

Method 1: In case that a subscribed HR local session AMBR is updated according to a change in subscriber information, a UDM may report the updated subscribed HR local session AMBR value to an H-SMF. The H-SMF may transmit the updated subscribed HR local session AMBR value to an H-PCF, and may obtain a new authorized HR local session AMBR value from the H-PCF. The newly produced authorized HR local session AMBR value may be transferred to a V-SMF so as to be applied to V-UPF1 and V-UPF2.

Method 2: In case that a subscribed HR local session AMBR is updated according to a change in subscriber information, a UDM may report the updated subscribed HR local session AMBR value to an H-SMF. The H-SMF may transfer the updated subscribed HR local session AMBR value to a V-SMF, and may perform control so that the value is applied to V-UPF1 and V-UPF2. In addition, in case that the subscribed HR local session AMBR is decreased, the H-SMF may adjust the maximum bit rate value implemented (enforcement) in the H-UPF.

Method 3: In case that a subscribed HR local session AMBR is updated according to a change in subscriber information, a UDM may report the updated subscribed HR local session AMBR value to a V-SMF. The V-SMF may immediately apply the updated subscribed HR local session AMBR value to a V-UPF. Alternatively, in case that the updated subscribed HR local session AMBR value is higher than an HR local session AMBR constraint value provided from a VPLMN, an H-SMF may be informed that the subscribed HR local session AMBR is higher than the HR local session AMBR constraint value. In addition, by taking into consideration that the HR local session AMBR constraint is lower than the subscribed HR local session AMBR, the H-SMF may adjust the maximum bit rate implemented (enforcement) in an H-UPF.

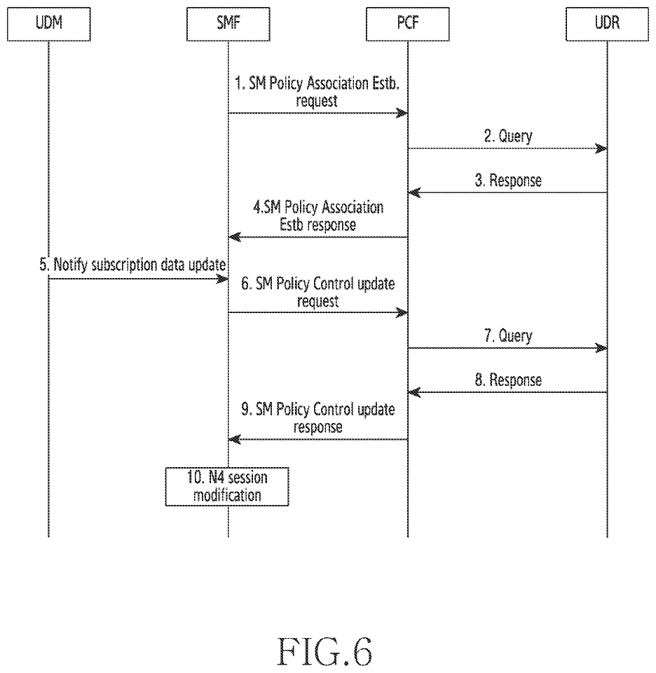

In addition to Methods 1 to 3, an HR local session-AMBR update method may be performed according to a method described with reference to FIG. 6 given below.

FIG. 6 illustrates a scheme of updating an HR local session-AMBR disclosed by an SMF according to an embodiment.

In Operation 1, the SMF may transmit, to a PCF, an HR local session establishment allow indicator and at least one of a UE identifier, a PDU session identifier, a serving PLMN ID (or a VPLMN ID) of a UE, an HR local session-AMBR constraint in a serving PLMN ID, an HPLMN ID, a subscribed HR local session-AMBR, a DNN, an S-NSSAI, a DNAI (an identifier of an access point of a local part of a data network to which an HR local session is to be connected), and may request related policy information. The information that the SMF transmits to the PCF may be information obtained from an AMF or a UDM.

In Operation 2, upon receiving an HR local session establishment allow indicator from the SMF, the PCF may request, from a UDR, session related policy information needed for establishing an HR local session. In this instance, the PCF may also provide, to the UDR, the information received from the SMF previously in Operation 1, and may obtain policy information and subscriber information corresponding to the corresponding information.

In case that the PCF does not receive, from the SMF, information related to whether establishment of an HR local session is allowed, the PCF may request related UE subscriber information or policy information stored in the UDR.

In Operation 3, the UDR may transmit, to the PCF, at least one of information associated with whether establishment of an HR local session is allowed, and a subscribed HR local session-AMBR.

In Operation 4, the PCF may determine an HR local session-AMBR (expressed as an authorized HR local session-AMBR) in consideration of the information obtained in Operation 1 from the SMF and the information obtained in Operation 3 from the UDR, and may transmit the same to the SMF as a response to Operation 1. The SMF may apply the HR local session-AMBR to a UPF connected to the SMF or may provide an HR local session AMBR value newly received from the PCF to another connected SMF (e.g., a V-SMF), and an SMF that receives a finally updated HR local session AMBR value may configure an HR local session AMBR value for a connected UPF (e.g., a UPF that acts as a UL CL or a BP).

In Operation 5, the UDM may transmit together, to the SMF, a subscribed HR local session AMBR value updated according to a change in subscriber information and at least one of a corresponding PDU session identifier, a DNN, an S-NSSAI, a DNAI, or a serving PLMN ID (VPLMN ID).

In Operation 6, the SMF may transmit, to the PCF, the updated subscribed HR local session AMBR value updated according to a change in subscriber information and at least one of a corresponding PDU session identifier, a DNN, an S-NSSAI, a DNAI, or a serving PLMN ID (VPLMN ID), received from the UDM, and may request new SM policy information.

In Operations 7 and 8, the PCF may obtain, from the UDR, related subscriber information and policy information needed for updating the SM policy information in response to the request received from the SMF.

In Operation 9, the PCF may determine a new HR local session AMBR value in consideration of the subscribed HR local session AMBR value received from the SMF and the information obtained from the UDR, and may provide the new HR local session AMBR to the SMF.

In Operation 10, the SMF may perform an N4 session modification procedure in order to configure, for the connected UPF, the new HR local session AMBR value obtained from the PCF. Alternatively, the SMF may provide, to another SMF (e.g., a V-SMF), the HR local session AMBR value newly received from the PCF, and an SMF that receives a finally updated HR local session AMBR value may configure the HR local session AMBR value for a connected UPF (e.g., a UPF that acts as a UL CL or a BP).

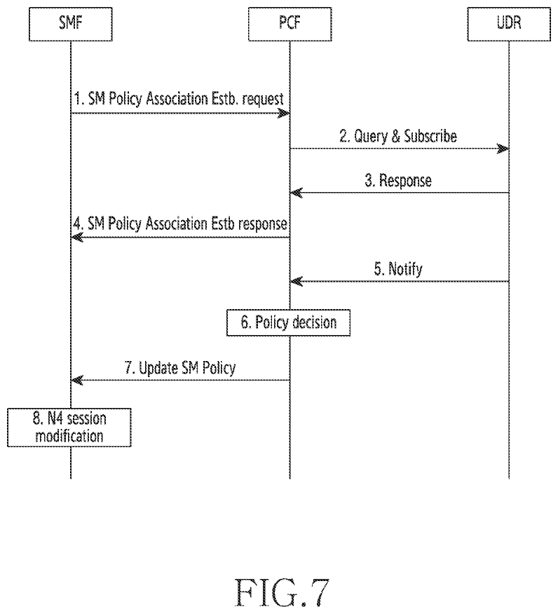

FIG. 7 illustrates a scheme of updating an HR local session-AMBR disclosed by a PCF according to an embodiment.

In Operation 1, an SMF may transmit, to a PCF, an HR local session establishment allow indicator and at least one among a UE identifier, a PDU session identifier, a serving PLMN ID (or VPLMN ID) of a UE, an HR local session-AMBR constraint in a serving PLMN ID, an HPLMN ID, a subscribed HR local session-AMBR, a DNN, an SNSSAI, and a DNAI (an identifier of an access point of a local part of a data network to which an HR local session is to be connected), and may request related policy information. The information that the SMF transmits to the PCF may be information obtained from an AMF, another SMF (e.g., a V-SMF), or a UDM.

In Operation 2, upon receiving an HR local session establishment allow indicator from the SMF, the PCF may request, from a UDR, session related policy information needed for establishing an HR local session. In this instance, the PCF may also provide, to the UDR, the information received in Operation 1 from the SMF, and may obtain policy information and subscriber information corresponding to the corresponding information.

In case that the PCF does not receive, from the SMF, information related to whether establishment of an HR local session is allowed, the PCF may request related UE subscriber information or policy information stored in the UDR.

The PCF may simultaneously request subscription in order to receive a notification when the information received from the UDR is updated. The PCF may provide notification target address information together, in order to transmit a subscription request to the UDR.

In Operation 3, the UDR may transmit, to the PCF, information associated with whether establishment of an HR local session is allowed, and a subscribed HR local session-AMBR. In case that the PCF requests subscription, the UDR may provide together, to the PCF, a notification identifier or a subscription identifier.

In Operation 4, the PCF may determine an HR local session-AMBR (expressed as an authorized HR local session-AMBR) in consideration of the information obtained in Operation 1 from the SMF and the information obtained in Operation 3 from the UDR, and may transmit the same to the SMF as a response to Operation 1.

In Operation 5, the UDR may transmit together, to the PCF, a subscribed HR local session AMBR value updated according to a change in subscriber information and at least one of a corresponding PDU session identifier, a DNN, an S-NSSAI, a DNAI, or a serving PLMN ID (VPLMN ID).

In Operation 6, the PCF may determine a new HR local session AMBR value in consideration of the updated subscribed HR local session AMBR value received from the UDR.

In Operation 7, the PCF may transmit the updated HR local session AMBR value to the SMF. In this instance, the UE identifier, the PDU session identifier, or at least one of a DNN, an S-NSSAI, a DNAI, and a serving PLMN ID (VPLMN ID) may be provided in order to provide PDU session information of a PDU session to which the corresponding HR local session AMBR value needs to be applied.

In Operation 8, the SMF may perform an N4 session modification procedure in order to configure, for a connected UPF, the new HR local session AMBR value obtained from the PCF. Alternatively, the SMF may provide, to another SMF (e.g., a V-SMF), the HR local session AMBR value newly received from the PCF, and an SMF that receives a finally updated HR local session AMBR value may configure the HR local session AMBR value for a connected UPF (e.g., a UPF that acts as a UL CL or a BP).

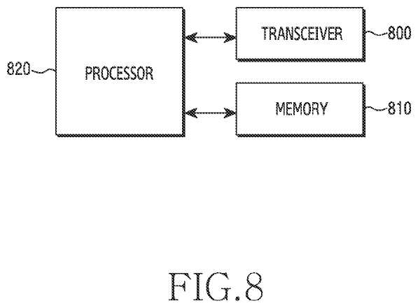

FIG. 8 illustrates a block diagram of the structure of a user equipment (UE) according to an embodiment.

As illustrated in FIG. 8, the UE may include a processor 820, transceiver 800, and a memory 810. However, the component elements of the UE are not limited to the above-descried example. For example, the UE may include more or fewer component elements than the above-described component elements. In addition, the processor 820, the transceiver 800, and the memory 810 may be embodied as a single chip.

The processor 820 may control a series of processes in which the UE operates according to the above-described embodiments. For example, the processor 820 may control component elements of the UE in order to implement a method of providing a broadcast service. The processor 820 may control the component elements of the UE to implement a program stored in the memory 810. In addition, the processor 820 may be an application processor (AP), a communication processor (CP), a circuit, an application-specific circuit, or at least one processor.

The transceiver 800 may perform signal transmission or reception with a network entity, another UE, or a base station. A signal in the signal transmission or reception performed with a network entity, another UE, or a base station may include control information and data. The transceiver 800 may include an RF transmitter that up-converts and amplifies a frequency of a transmitted signal, an RF receiver that low-noise amplifies a received signal and down-converts a frequency, and the like. This is merely an example of the transceiver 800, and the component elements of the transceiver 800 are not limited to an RF transmitter and an RF receiver. In addition, the transceiver 800 may receive a signal via a wireless channel and may output the same to the processor 820, and may transmit a signal output from the processor 820 via a wireless channel.

The memory 810 may store a program and data needed when the UE operates. In addition, the memory 810 may store control information or data included in a signal transmitted or received by the UE. The memory 810 may be configured as a storage medium such as ROM, RAM, hard disk, CD-ROM, DVD, and the like, or a combination of storage media. In addition, a plurality of memories 810 may be present. The memory 810 may store a program to implement the above-described method for providing a broadcast service.

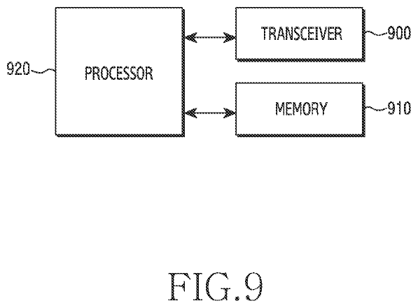

FIG. 9 illustrates a block diagram of the structure of a base station according to an embodiment.

As illustrated in FIG. 9, a base station may include a transceiver 920, a memory 900, and a processor 910. However, the component elements of the base station are not limited to the above-descried example. For example, the base station may include more or fewer component elements than the above-described component elements. In addition, the processor 920, the transceiver 900, and the memory 910 may be embodied as a single chip.

The processor 920 may control a series of processes in which a base station operates according to the above-described embodiments. For example, the processor 920 may control component elements of the base station in order to provide a broadcast service. The processor 920 may control the component elements of the base station to implement a program stored in the memory 910. In addition, the processor 920 may be an AP, a CP, a circuit, an application-specific circuit, or at least one processor.

The transceiver 900 may perform signal transmission or reception with a network entity, another base station, or a UE. A signal in the signal transmission or reception performed with a network entity, another base station, or a UE may include control information and data. The transceiver 900 may include an RF transmitter that up-converts and amplifies a frequency of a transmitted signal, an RF receiver that low-noise amplifies a received signal and down-converts a frequency, and the like. This is merely an example of the transceiver 900, and the component elements of the transceiver 900 are not limited to an RF transmitter and an RF receiver. In addition, the transceiver 900 may receive a signal via a wireless channel and output the same to the processor 920, and may transmit a signal output from the processor 920 via a wireless channel.

The memory 910 may store a program and data needed when the base station operates. In addition, the memory 910 may store control information or data included in a signal transmitted or received by the base station. The memory 910 may be configured as a storage medium such as ROM, RAM, hard disk, CD-ROM, DVD, and the like, or a combination of storage media. In addition, a plurality of memories 910 may be present. The memory 910 may store a program to implement the above-described method for providing a broadcast service.

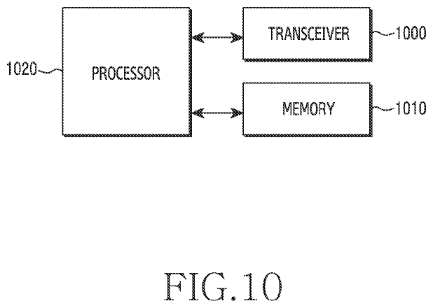

FIG. 10 illustrates a block diagram of the structure of a network entity according to an embodiment.

As illustrated in FIG. 10, the network entity of the disclosure may include a processor 1020, a transceiver 1000, and a memory 1010. However, the component elements of the network entity are not limited to the above-descried example. For example, the network entity may include more or fewer elements than the above-described component elements. In addition, the processor 1020, the transceiver 1000, and the memory 1010 may be implemented as a single chip.

The processor 1020 may control a series of processes in which an NF operates according to the above-described embodiments. For example, the processor 1020 may control component elements of a network entity in order to implement a method of providing a broadcast service. The processor 1020 may control the component elements of the NF to implement a program stored in the memory 1010. In addition, the processor 1020 may be an AP, a CP, a circuit, an application-specific circuit, or at least one processor.

The transceiver 1000 may perform signal transmission or reception with another network entity, a base station, or a UE. A signal in the signal transmission or reception performed with another network entity or a UE may include control information and data. The transceiver 1000 may include an RF transmitter that up-converts and amplifies a frequency of a transmitted signal, an RF receiver that low-noise amplifies a received signal and down-converts a frequency, and the like. This is merely an example of the transceiver 1000, and the component elements of the transceiver 1000 are not limited to an RF transmitter and an RF receiver. In addition, the transceiver 1000 may receive a signal via a wireless channel and output the same to the processor 1020, and may transmit a signal output from the processor 1020 via a wireless channel.

The memory 1010 may store a program and data needed when the network entity operates. In addition, the memory 1010 may store control information or data included in a signal transmitted or received by the network entity. The memory 1010 may be configured as a storage medium such as ROM, RAM, a hard disk, a CD-ROM, a DVD, and the like, or a combination of storage media. In addition, a plurality of memories 1010 may be present. The memory 1010 may store a program to implement the above-described method of providing a broadcast service.

The methods according to various embodiments described in the claims or the specification may be implemented by hardware, software, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described herein.

Such a program (e.g., software module, software) may be stored in a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored in a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment.

In the specific embodiments of the disclosure, the components are expressed in a singular or plural form. However, the singular or plural expression is appropriately selected according to a certain situation for the convenience of explanation, the disclosure is not limited to a single component or a plurality of components, the components expressed in the plural form may be configured as a single component, and the components expressed in the singular form may be configured as a plurality of components.

Meanwhile, while specific embodiments have been described herein, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of one embodiment may be combined with a part of a second embodiment to operate a base station and a terminal. Furthermore, although the above embodiments have been presented based on the frequency division duplex (FDD) LTE system, other variants based on the technical idea of the above embodiments may also be implemented in other systems such as time division duplex (TDD) LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description is merely for the sake of illustration, and embodiments of the disclosure are not limited to the embodiments set forth herein. Those skilled in the art will appreciate that the disclosure may be easily modified and changed into other specific forms without departing from the technical idea or essential features of the disclosure. Therefore, the scope of the disclosure should be determined not by the above detailed description but by the appended claims, and all modification sand changes derived from the meaning and scope of the claims and equivalents thereof shall be construed as falling within the scope of the disclosure.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a first session management function (SMF) entity, the method comprising:
receiving, from a second SMF entity, a request message for a protocol data unit (PDU) session associated with a home routed (HR) local session;
receiving, from a unified data management (UDM) entity, information on an aggregated maximum bit rate (AMBR) for the HR local session;
receiving, from a policy control function (PCF) entity, an authorized AMBR of the HR local session generated based on the information on the AMBR; and
transmitting, to the second SMF, a response message including the authorized AMBR.

2. The method of claim 1,
wherein the first SMF entity is a home-SMF (H-SMF) entity included in a home-public land mobile network (H-PLMN),
wherein the second SMF entity is a visited-SMF (V-SMF) entity included in a visited-public land mobile network (V-PLMN),
wherein the PCF entity is a home-PCF (H-PCF) included in the H-PLMN, and
wherein the HR local session is a session which is a local region of a data network (DN) in the V-PLMN.

3. The method of claim 1,
wherein the request message includes subscriber information associated with the V-PLMN, and
wherein the subscriber information includes a first AMBR of the HR local session and at least one of PLMN identifier (ID), data network name (DNN), single network slice selection assistance information (S-NSSAI), or data network access identifier (DNAI).

4. The method of claim 3,
wherein the information on the AMBR includes a second AMBR corresponding to at least one of or a combination of the PLMN ID, the DNN, the S-NSSAI, or the DNAI, and
wherein the second AMBR is stored in the UDM entity.

5. The method of claim 4,
wherein the authorized AMBR includes an authorized third AMBR based on the first AMBR and the second AMBR.

6. A method performed by a unified data management (UDM) entity, the method comprising:
receiving, from a first session management function (SMF) entity, information on a protocol data unit (PDU) session; and
transmitting, to the first SMF entity, information on an aggregated maximum bit rate (AMBR) associated with the PDU session,
wherein an authorized aggregated maximum bit rate (AMBR) of a home routed (HR) local session is generated based on the information on the AMBR, and
wherein the authorized AMBR is transmitted to a second SMF entity in response to a request message for the PDU session.

7. The method of claim 6,
wherein the first SMF entity is a home-SMF (H-SMF) entity included in a home-public land mobile network (H-PLMN),
wherein the second SMF entity is a visited-SMF (V-SMF) entity included in a visited-public land mobile network (V-PLMN),
wherein a policy control function (PCF) entity is a home-PCF (H-PCF) included in the H-PLMN, and
wherein the HR local session is a session which is a local region of a data network (DN) in the V-PLMN.

8. The method of claim 7,
wherein the request message includes subscriber information associated with the V-PLMN, and
wherein the subscriber information includes a first AMBR of the HR local session and at least one of PLMN identifier (ID), data network name (DNN), single network slice selection assistance information (S-NSSAI), or data network access identifier (DNAI).

9. The method of claim 8,
wherein the information on the AMBR includes a second AMBR corresponding to at least one of or a combination of the PLMN ID, the DNN, the S-NSSAI, or the DNAI, and
wherein the second AMBR is stored in the UDM entity.

10. The method of claim 9,
wherein the authorized AMBR includes an authorized third AMBR based on the first AMBR and the second AMBR.

11. A first session management function (SMF) entity in a wireless communication system, the first SMF comprising:
a transceiver; and
at least one processor coupled with the transceiver and configured to:
receive, from a second SMF entity, a request message for a protocol data unit (PDU) session associated with a home routed (HR) local session,
receive, from a unified data management (UDM) entity, information on an aggregated maximum bit rate (AMBR) for the HR local session,
receive, from a policy control function (PCF) entity, an authorized AMBR of the HR local session generated based on the information on the AMBR, and
transmit, to the second SMF, a response message including the authorized AMBR.

12. The first SMF of claim 11,
wherein the first SMF entity is a home-SMF (H-SMF) entity included in a home-public land mobile network (H-PLMN),
wherein the second SMF entity is a visited-SMF (V-SMF) entity included in a visited-public land mobile network (V-PLMN),
wherein the PCF entity is a home-PCF (H-PCF) included in the H-PLMN, and
wherein the HR local session is a session which is a local region of a data network (DN) in the V-PLMN.

13. The first SMF of claim 11,
wherein the request message includes subscriber information associated with the V-PLMN, and
wherein the subscriber information includes a first AMBR of the HR local session and at least one of PLMN identifier (ID), data network name (DNN), single network slice selection assistance information (S-NSSAI), or data network access identifier (DNAI).

14. The first SMF of claim 13,
wherein the information on the AMBR includes a second AMBR corresponding to at least one of or a combination of the PLMN ID, the DNN, the S-NSSAI, or the DNAI, and
wherein the second AMBR is stored in the UDM entity.

15. The first SMF of claim 14,
wherein the authorized AMBR includes an authorized third AMBR based on the first AMBR and the second AMBR.

16. A unified data management (UDM) entity in a wireless communication system, the UDM entity comprising:
a transceiver; and
at least one processor coupled with the transceiver and configured to:
receive, from a first session management function (SMF) entity, information on a protocol data unit (PDU) session, and
transmit, to the first SMF entity, information on an aggregated maximum bit rate (AMBR) associated with the PDU session,
wherein an authorized AMBR of a home routed (HR) local session generated based on the information on the AMBR, and
wherein the authorized AMBR is transmitted to a second SMF entity in response to a request message for the PDU session.

17. The UDM entity of claim 16,
wherein the first SMF entity is a home-SMF (H-SMF) entity included in a home-public land mobile network (H-PLMN),
wherein the second SMF entity is a visited-SMF (V-SMF) entity included in a visited-public land mobile network (V-PLMN),
wherein a policy control function (PCF) entity is a home-PCF (H-PCF) included in the H-PLMN, and
wherein the HR local session is a session which is a local region of a data network (DN) in the V-PLMN.

18. The UDM entity of claim 16,
wherein the request message includes subscriber information associated with the V-PLMN, and
wherein the subscriber information includes a first AMBR of the HR local session and at least one of PLMN identifier (ID), data network name (DNN), single network slice selection assistance information (S-NSSAI), or data network access identifier (DNAI).

19. The UDM entity of claim 18,
wherein the information on the AMBR includes a second AMBR corresponding to at least one of or a combination of the PLMN ID, the DNN, the S-NSSAI, or the DNAI, and
wherein the second AMBR is stored in the UDM entity.

20. The UDM entity of claim 19,
wherein the authorized AMBR includes an authorized third AMBR based on the first AMBR and the second AMBR.
